(19) United States
(12) Patent Application Publication
(10) Pub. No.: US 2008/0205744 A1
(43) Pub. Date: Aug. 28, 2008

(54) Drawing Point Data Obtainment Method and Apparatus

(76) Inventor: Mitsuru Mushano, Kanagawa-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/992,772

(22) PCT Filed: Sep. 25, 2006
(86) PCT No.: PCT/JP2006/319620

§ 371 Date: Mar. 28, 2008

(30) Foreign Application Priority Data
Sep. 29, 2005 (JP) 2005-284860

(51) Int. Cl. G06K 9/00

(52) U.S. Cl. 382/144

(57) ABSTRACT

In a method for obtaining drawing point data that is used for drawing an image on a substrate by moving, relative to the substrate, a plurality of drawing point formation units for forming drawing points based on the drawing point data and by sequentially forming, based on the movement, drawing points on the substrate, an address in a memory, at which image data representing an image corresponding to a drawing start position of each of drawing point formation units is stored, is obtained as a readout start address of each of the drawing point formation units. Further, drawing point data for each of the drawing point formation units is obtained by sequentially reading out image data from respective readout start addresses along the respective drawing point data paths in image data corresponding to the drawing paths of the drawing point formation units on the substrate.

### TECHNICAL FIELD

The present invention relates to a drawing method and a drawing apparatus for drawing an image by moving a plurality of drawing point formation units for forming drawing points based on drawing point data relative to a substrate and by sequentially forming drawing points according to the movement. The present invention also relates to a method and an apparatus for obtaining drawing point data, the method and the apparatus being used in the drawing method and the drawing apparatus.

### BACKGROUND ART

Conventionally, various exposure apparatuses utilizing photolithographic techniques have been proposed as apparatuses for recording predetermined patterns on printed circuit boards or substrates of panel displays.

As such exposure apparatuses, an exposure apparatus for forming a circuit pattern by passing (scanning) a light beam across a substrate, to which photoresist has been applied, in a main scan direction and in a sub-scan direction and by modulating the light beam based on exposure image data representing a circuit pattern has been proposed, for example.

Further, as such exposure apparatuses, an exposure apparatus for performing exposure, for example, by utilizing a spatial light modulation device, such as a digital micromirror device (hereinafter, referred to as “DMD”), has been proposed. In the exposure apparatus, exposure is performed by modulating a light beam, based on exposure image data, by the spatial light modulation device.

As an exposure apparatus using the DMD, as described above, an exposure apparatus for forming a desired image on an exposure surface has been proposed (for example, Japanese Unexamined Patent Publication No. 2004-233718). In the exposure apparatus, the desired image is formed by moving the DMD relative to the exposure surface, by inputting a multiplicity of sets of exposure point data corresponding to a multiplicity of micromirrors of the DMD according to themovement, andby sequentially forming a group of drawingpoints corresponding to the micromirrors of the DMD in time series.

Further, an exposure apparatus, in which a DMD is set in such a manner that rows of micromirrors of the DMD are inclined by a predetermined angle with respect to a relative movement direction of the DMD, has been proposed. Accordingly, it is possible to form a high resolution exposure image by exposure.

When exposure is performed using the exposure apparatuses, as described above, exposure point data corresponding to each position of the DMD relative to the exposure surface is sequentially input to the DMD as the DMD moves. The drawing point data is obtained, for example, by converting exposure image data in vector format, which has been generated by a data generation apparatus including a CAD (computer-aided design) station, a CAM (computer-aided manufacturing) station or the like, into exposure image data in raster format and by reading out pixel data corresponding to each position of the DMD relative to the exposure surface from the exposure image data in raster format.

However, when exposure point data corresponding to each position of the DMD is obtained, as described above, the resolution of exposure points is higher than that of exposure image data. Therefore, the data volume of the exposure point data becomes much higher than that of the exposure image data. Hence, a high capacity memory is required to store the exposure point data, thereby increasing cost.

Further, the exposure point data, which has been obtained as described above, is temporarily stored in a PC (personal computer) or the like and predetermined correction processing is performed on the exposure point data in the PC. Then, the processed exposure point data is output from the PC to hardware for performing exposure. At this time, if the data volume of the exposure point data is very high, transfer time becomes long, thereby reducing processing efficiency.

Further, the exposure point data, which has been obtained as described above, is read out from the exposure image data based on the position of each of micromirrors of the DMD. Since the pitch of the micromirrors is much larger than the resolution of the exposure image data, an exposure point data group obtained at each position of the DMD does not have the feature of images.

Therefore, when the data volume is reduced, for example, by performing run-length compression on the exposure point data group, which has been obtained as described above, the compression rate is low because the exposure point data group does not have the feature of images.

### DISCLOSURE OF THE INVENTION

In view of the foregoing circumstances, it is an object of the present invention to provide a drawing method and a drawing apparatus, in which drawing point data that has the feature of images can be obtained, and in which drawing point data, of which the data volume can be further reduced, can be obtained, in the exposure apparatus as described above. Further, it is also an object of the present invention to provide a method and an apparatus for obtaining such drawing point data.

A method for obtaining drawing point data according to the present invention is a method for obtaining drawing point data that is used when an image is drawn on a substrate by moving a plurality of drawing point formation units for forming drawing points based on drawing point data relative to the substrate and by sequentially forming the drawing points on the substrate according to the movement, the method comprising the steps of:

obtaining a drawing point data path corresponding to the drawing path of each of the drawing point formation units by associating the drawing path of each of the drawing point formation units on the substrate and image data representing the image with each other;

selecting the same position in each of the drawing point data paths with respect to the extending direction of the drawing point data paths as a readout start position in each of the drawing point data paths; and

obtaining drawing point data for each of the drawing point formation units by sequentially reading out the image data from the readout start position in each of the drawing point data paths along each of the drawing point data paths.

Further, in a method for obtaining drawing point data according to the present invention, the drawing point data in each of the drawing point data paths may be sequentially obtained along the arrangement direction of the drawing point data paths.

Further, after the drawing point data for each of the drawing point formation units is obtained, a predetermined number of sets of margin data may be appended to the beginning and the end of each of the drawing point data strings for each of the drawing point formation units. Further, the drawing point data for each of the drawing point formation units may be obtained by extracting and reading out the drawing point data corresponding to each of the drawing point data paths and a part of the margin data from each of the drawing point data strings to which the margin data has been appended.

Further, at least one representative drawing point data path, representing the plurality of drawing point data paths, may be obtained. The number of the at least one representative drawing point data path is less than the number of the plurality of drawing point data paths. Then, the drawing point data for each of the plurality of drawing point formation units corresponding to the plurality of drawing point data paths may be obtained by reading out the image data a plurality of times from the readout start position along the obtained representative drawing point data path.

Here, the “representative drawing point data path” may be obtained from the “plurality of drawing point data paths”. Alternatively, an imaginary drawing point data path, which is different from any of the “plurality of drawing point data paths” may be set, and the imaginary drawing point data path may be used as the “representative drawing point data path”.

Further, the plurality of drawing point formation units may be two-dimensionally arranged.

Further, a row of drawing point formation units, including a plurality of drawing point formation units, may be inclined by a predetermined inclination angle with respect to the direction of the movement.

A drawing method according to the present invention is characterized in that drawing point data is obtained by using the method for obtaining drawing point data according to the present invention, and that an image is drawn on the substrate based on the obtained drawing point data.

An apparatus for obtaining drawing point data according to the present invention is an apparatus for obtaining drawing point data that is used when an image is drawn on a substrate by moving a plurality of drawing point formation units for forming drawing points based on drawing point data relative to the substrate and by sequentially forming the drawing points on the substrate according to the movement, the apparatus comprising:

a drawing point data path obtainment means for obtaining a drawing point data path corresponding to the drawing path of each of the drawing point formation units by associating the drawing path of each of the drawing point formation units on the substrate and image data representing the image with each other; and an ideal drawing point data obtainment means for obtaining drawing point data for each of the drawing point formation units by selecting the same position in each of the drawing point data paths with respect to the extending direction of the drawing point data paths as a readout start position in each of the drawing point data paths and by sequentially reading out the image data from the readout start position in each of the drawing point data paths along each of the drawing point data paths.

The ideal drawing point data obtainment means may sequentially obtain the drawing point data in each of the drawing point data paths along the arrangement direction of the drawing point data paths.

An apparatus for obtaining drawing point data according to the present invention may further include a margin data appending means for appending a predetermined number of sets of margin data to the beginning and the end of each of the drawing point data strings for each of the drawing point formation units, each of the drawing point data strings being obtained by the ideal drawing point data obtainment means, and a drawing point data obtainment means for obtaining the drawing point data for each of the drawing point formation units by extracting and reading out the drawing point data corresponding to each of the drawing point data paths and a part of the margin data from each of the drawing point data strings to which the margin data has been appended by the margin data appendix means.

Further, an apparatus for obtaining drawing point data according to the present invention may further include an ideal representative drawing point data path obtainment means for obtaining at least one representative drawing point data path, representing the plurality of drawing point data paths. The number of the at least one representative drawing point data path is less than that of the plurality of drawing point data paths. The ideal drawing point data obtainment means may obtain the drawing point data for each of the plurality of drawing point formation units corresponding to the plurality of drawing point data paths by reading out the image data a plurality of times from the readout start position along the representative drawing point data path obtained by the ideal representative drawing point data path obtainment means.

Further, the plurality of drawing point formation units may be two-dimensionally arranged.

Further, a row of drawing point formation units, including a plurality of drawing point formation units, may be inclined by a predetermined inclination angle with respect to the direction of the movement.

A drawing apparatus according to the present invention includes the apparatus for obtaining drawing point data according to the present invention and a drawing means for drawing an image on the substrate based on the drawing point data obtained by the apparatus for obtaining drawing point data.

According to a method and an apparatus for obtaining drawing point data of the present invention and a drawing method and a drawing apparatus of the present invention, a drawing point data path corresponding to the drawing path of each of the drawing point formation units is obtained by associating the drawing path of each of the drawing point formation units on the substrate and image data representing an image with each other. Then, the same position in each of the drawing point data paths with respect to the extending direction of the drawing point data paths is selected as a readout start position in each of the drawing point data paths. Then, drawing point data for each of the drawing point formation units is obtained by sequentially reading out the image data from the readout start position in each of the drawing point data paths along each of the drawing point data paths. Therefore, it is possible to obtain the drawing point data that has the feature of images. Further, when run-length compression is performed, it is possible to improve the compression rate, thereby further reducing a data volume.

### BRIEF DESCRIPTION OF THE DRAWINGS

FIG. 1 is a schematic perspective view illustrating the configuration of an exposure apparatus using an embodiment of a method and an apparatus for obtaining drawing point data, a drawing method and a drawing apparatus according to the present invention;

FIG. 2 is a perspective view illustrating the configuration of a scanner of the exposure apparatus illustrated in FIG. 1;

FIG. 3A is a plan view illustrating exposed areas formed on the exposure surface of a substrate;

FIG. 3B is a plan view illustrating the arrangement of exposed areas formed by exposure heads;

FIG. 4 is a diagram illustrating a DMD in an exposure head of the exposure apparatus illustrated in FIG. 1;

FIG. 5 is a block diagram illustrating the electrical configuration of an exposure apparatus according to an embodiment of the present invention;

FIG. 6 is a diagram illustrating an example of exposure image data;

FIG. 7 is a diagram illustrating a correspondence between the exposure point data path for each micromirror and the coordinate system of exposure image data;

FIG. 8 is a diagram illustrating an example of ideal mirror data;

FIG. 9 is a diagram illustrating an example of ideal mirror data with margin;

FIG. 10 is a diagram for explaining an example of a method for compressing ideal mirror data;

FIG. 11 is a diagram illustrating an example of mirror data obtained by each of the micromirrors;

FIG. 12 is a diagram illustrating an example of frame data;

FIG. 13 is a diagram for explaining ideal representative exposure point data path;

FIG. 14 is a diagram illustrating a correspondence between ideal representative mirror data with margin and the exposure point data path for each of the micromirrors;

FIG. 15 is a table used when margin data is appended in a hardware processing unit;

FIG. 16 is a diagram illustrating base marks provided on the substrate;

FIG. 17 is a diagram for explaining a method for obtaining an exposure path of each of the micromirrors on the substrate based on information about detection positions of the base marks;

FIG. 18 is a diagram for explaining a method for obtaining an exposure point data path in exposure image data, the exposure point data path corresponding to the exposure path of each of the micromirrors on the substrate; and

FIG. 19 is a diagram for explaining a comparative example for explaining the advantageous effect of the present invention.

### BEST MODE FOR CARRYING OUT THE INVENTION

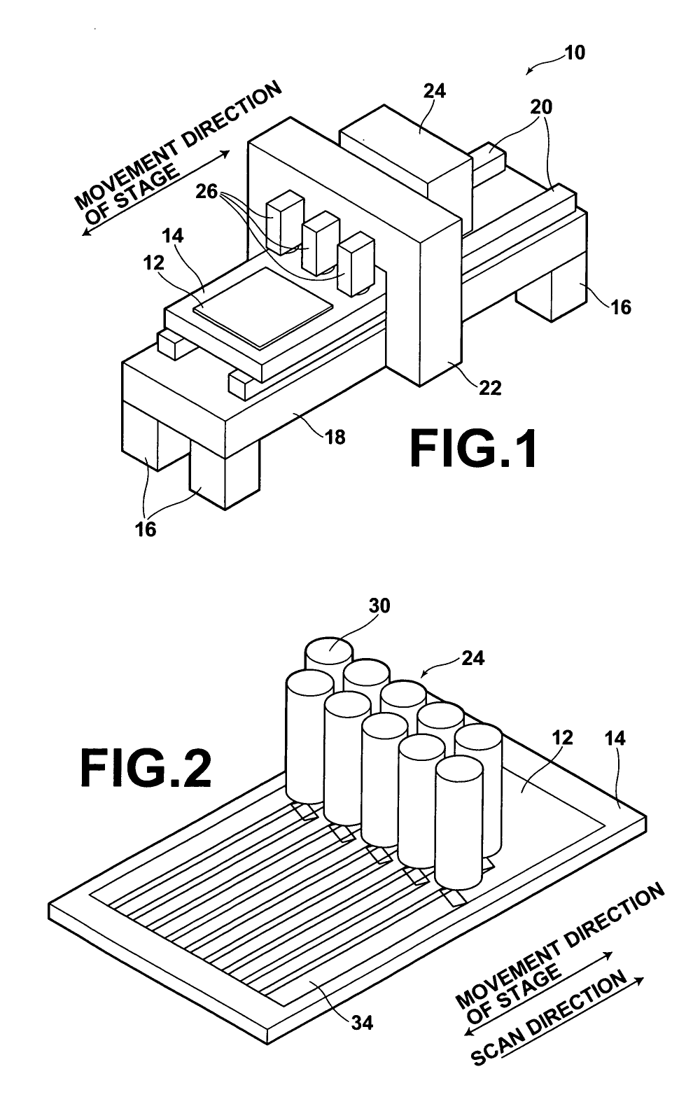

Hereinafter, an exposure apparatus using an embodiment of a method and an apparatus for obtaining drawing point data according to the present invention and a drawing method and a drawing apparatus according to the present invention will be described in detail with reference to the attached drawings. FIG. 1 is a schematic perspective view illustrating the configuration of an exposure apparatus using an embodiment of the present invention. The exposure apparatus using an embodiment of the present invention is an apparatus for exposing each layer of a multi-layer printed circuit board to light to form a circuit pattern therein. The exposure apparatus is characterized by a method for obtaining exposure point data, which is used to expose each layer of the multi-layer printed circuit board to light to form the circuit pattern therein. First, the schematic configuration of the exposure apparatus will be described.

An exposure apparatus 10 includes a movement stage 14, as illustrated in FIG. 1. The movement stage 14 has a flat plate shape, and holds a substrate 12 on the surface thereof by suction. Further, two guides 20 are provided on the upper surface of a base 18 supported by four legs 16. The base 18 has a thick plate shape, and the guides 20 extend along the movement direction of the stage. The movement stage 14 is arranged so that the longitudinal direction of the movement stage 14 is parallel to the movement direction of the stage 14. Further, the movement stage 14 is supported by the guides 20 in such a manner that the movement stage 14 can move back and forth.

Further, a C-shaped gate 22 is provided at a central portion of the base 18 in such a manner that the C-shaped gate 22 straddles the movement path of the movement stage 14. Each end of the C-shaped gate 22 is fixed onto either side of the base 18. Further, a scanner 24 is provided on one side of the gate 22, and a plurality of cameras 26 is provided on the other side of the gate 22. The plurality of cameras 26 is provided to detect a leading edge and a rear edge of the substrate 12.

Each of the scanner 24 and the cameras 26 is mounted on the gate 22 and placed at a fixed position over the movement path of the movement stage 14. Further, the scanner 24 and the cameras 26 are connected to a controller or controllers for controlling them (the controller will be described later).

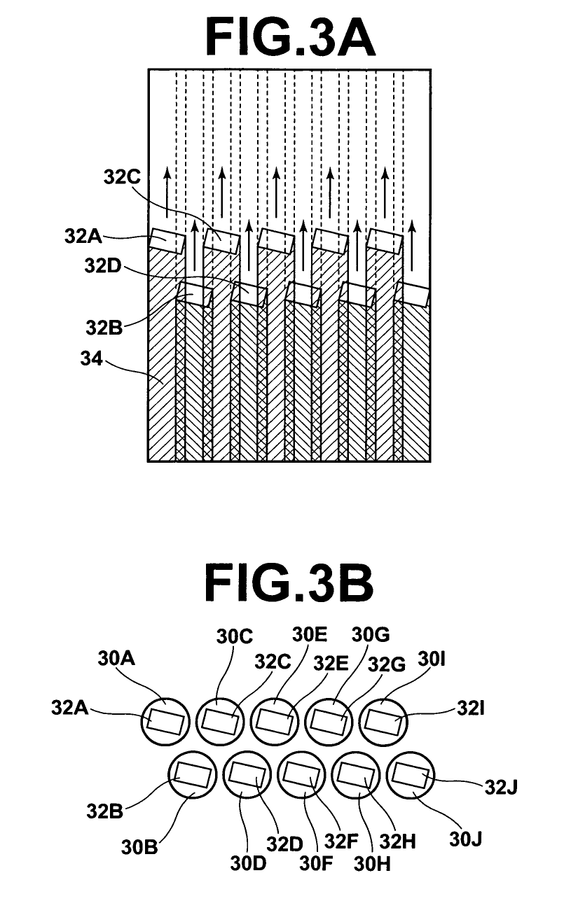

The scanner 24 includes ten exposure heads 30 (30A through 30J), as illustrated in FIG. 2 and FIG. 3B. The ten exposure heads 30 are substantially arranged in a matrix shape of two rows by five columns.

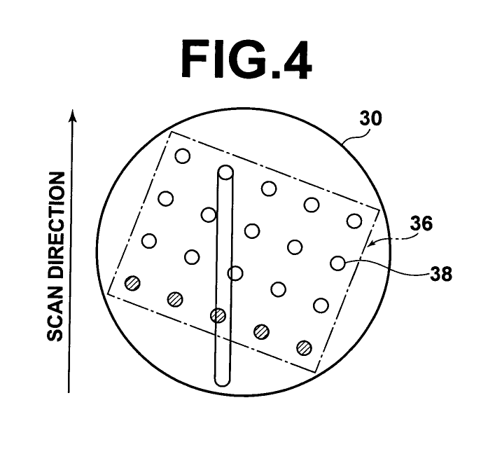

In each of the exposure heads 30, a digital micromirror device (DMD) 36 is provided, as illustrated in FIG. 4. The digital micromirror device 36 is a spatial light modulation device (SLM) for performing spatial modulation on a light beam that has entered the spatial light modulation device. In the DMD 36, a multiplicity of micromirrors 38 is two-dimensionally arranged in orthogonal directions. The DMD 36 is mounted in such a manner that the column direction of the micromirrors 38 forms a predetermined set inclination angle θ (0°<θ<90°) with respect to the scan direction. Therefore, an exposure area 32 formed by each of the exposure heads 30 is a rectangular area inclined with respective to the scan direction. As the movement stage 14 moves, a band-shaped exposed area 34 is formed by each of the exposure heads 30, as illustrated in FIG. 3A. A light source for emitting a light beam that enters each of the exposure heads 30 is omitted in the drawings. A laser light source or the like may be used as the light source.

ON/OFF of each of the micromirrors 38 of the DMD 36, which is provided in each exposure head 30, is controlled micromirror by micromirror. Accordingly, dot patterns (black/white) corresponding to the micromirrors 38 of the DMD 36 are formed on the substrate 12. The band-shaped exposed area 34, which has been described above, is formed by two-dimensionally arranged dots corresponding to the micromirrors 38, which are illustrated in FIG. 4. Further, since the DMD 36 is inclined with respect to the scan direction, as described above, it is possible to further narrow intervals between exposure points arranged in a direction perpendicular to the scan direction. Hence, it is possible to increase the resolution. There are some cases in which some of the dots are not used because of a variance in adjustment of the inclination angle. For example, in FIG. 4, shaded dots are not used, and micromirrors 38 of the DMD 36 corresponding to these dots are always in an OFF state.

Further, as illustrated in FIGS. 3A and 3B, the exposure heads 30 in each row, arranged in a line, are shifted from the exposure heads 30 in the other row by a predetermined distance so that each of the band-shaped exposed areas 34 partially overlaps with an adjacent exposed area or adjacent exposed areas 34. Therefore, an unexposed area between an exposure area 32A on the most left side of the first row and an exposure area 32C on the right side of the exposure area 32A in the first row is exposed to light by an exposure area 32B on the most left side of the second row, for example. Similarly, an unexposed area between the exposure area 32B and an exposure area 32D on the right side of the exposure area 32B is exposed to light by the exposure area 32C.

Next, the electrical configuration of the exposure apparatus 10 will be described.

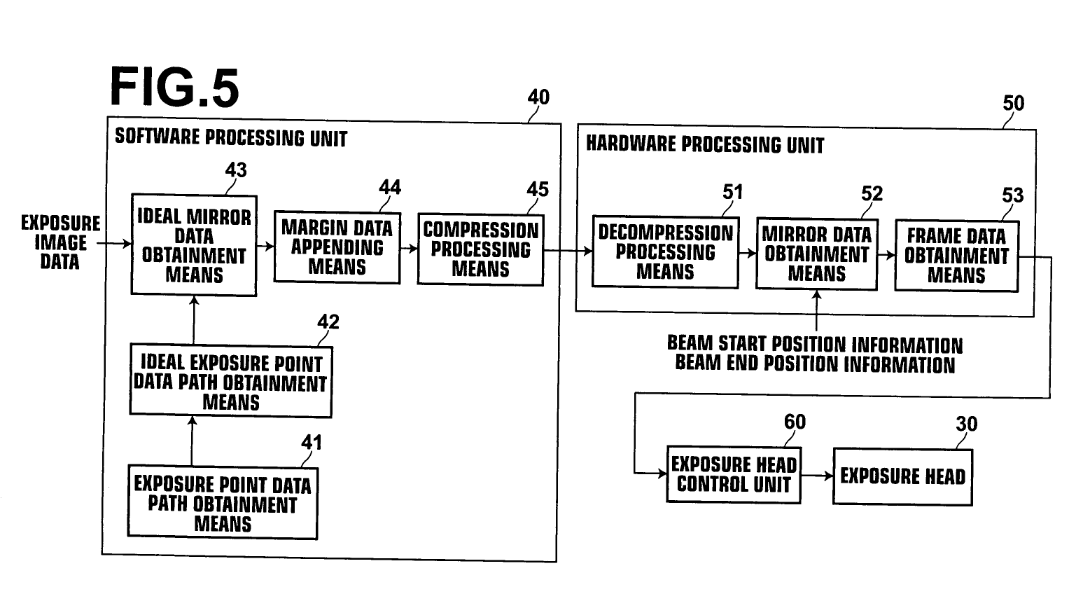

The exposure apparatus 10 includes a software processing unit 40 and a hardware processing unit 50, as illustrated in FIG. 5. The software processing unit 40 mainly performs processing by software, and the hardware processing unit 50 mainly performs processing by hardware.

The software processing unit 40 includes an exposure point data path obtainment means 41, an ideal exposure point data path obtainment means 42, an ideal mirror data obtainment means 43, a margin data appending means 44 and a compression processing means 45. The exposure point data path obtainment means 41 obtains an exposure point data path for each of the micromirrors 38 in the coordinate system of exposure image data. The ideal exposure point data path obtainment means 42 obtains an ideal exposure point data path based on the exposure point data path obtained by the exposure point data path obtainment means 41. The ideal exposure point data path will be described later. The ideal mirror data obtainment means 43 receives exposure image data representing a circuit pattern to be formed by exposure. The ideal mirror data obtainment means 43 also receives the ideal exposure point data path output from the ideal exposure point data path obtainment means 42. Then, the ideal mirror data obtainment means 43 obtains, based on the ideal exposure point data path, ideal mirror data from the exposure image data. The ideal mirror data will be described later. The margin data appending means 44 appends margin data to the ideal mirror data obtained by the ideal mirror data obtainment means 43. The margin data will be described later. The compression processing means 45 performs run-length compression processing on the ideal mirror data to which the margin data has been appended by the margin data appending means 44 (hereinafter, the ideal mirror data to which the margin data has been appended is referred to as “ideal mirror data with margin”). The exposure point data path, the ideal exposure point data path, the ideal mirror data and the margin data will be described in detail later. In the present embodiment, the run-length compression processing is performed. However, other compression methods may be adopted.

The hardware processing unit 50 includes a decompression processing means 51, a mirror data obtainment means 52 and a frame data obtainment means 53. The decompression processing means 51 receives compressed exposure image data, which has been output from the compression processing means 45 of the software processing unit 40, and performs decompression processing on the compressed exposure image data. The mirror data obtainment means 52 obtains, based on beam start position information and beam end position information, mirror data for each of the micromirrors 38 from the ideal mirror data with margin that has been decompressed by the decompression processing means 51. The beam start position information and the beam end position information will be described later. The frame data obtainment means 53 obtains frame data, which will be described later, by performing 90 degrees rotation processing or transposition processing using a matrix on the mirror data for each of the micromirrors 38, which has been obtained by the mirror data obtainment means 52.

Further, the exposure apparatus 10 includes an exposure head control unit 60, a movement mechanism (not illustrated in the drawings) for moving the movement stage 14 in the movement direction of the stage and a controller (not illustrated in the drawings) for controlling the whole exposure apparatus of the present invention. The exposure head control unit 60 outputs a control signal, based on the frame data obtained by the hardware processing unit 50, to each of the exposure heads 30. As the movement mechanism, a mechanism that has any known structure may be adopted as long as the mechanism can move the movement stage 14 back and forth along the guides 20.

The action of each of the aforementioned elements will be described later.

Next, the action of the exposure apparatus 10 will be described with reference to the attached drawings.

First, exposure image data in raster format representing a circuit pattern to be formed on the substrate 12 by exposure is generated. The exposure image data in raster format is input to the ideal mirror data obtainment means 43 and temporally stored in a memory (not illustrated in the drawings) by the ideal mirror data obtainment means 43.

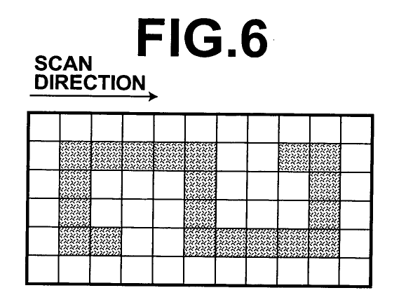

In the present embodiment, a case in which a circuit pattern, as illustrated in FIG. 6, is formed by exposure will be described. Each square in the grid illustrated in FIG. 6 represents pixel data, which is a minimum unit forming the exposure image data. For the purpose of explanation, processing in which the circuit pattern illustrated in FIG. 6 is formed by performing exposure by a single exposure head 30 will be described. However, it is assumed that similar processing is also performed by the other exposure heads 30.

The exposure image data is stored, as described above. Further, the exposure point data path obtainment means 41 obtains beam start position information and beam end position information on the substrate 12 for each of the micromirrors 38. Then, a projection point in the coordinate system of the exposure image data corresponding to the beam start position information and a projection point in the coordinate system of the exposure image data corresponding to the beam end position information are obtained. Further, an exposure point data path for each of the micromirrors 38, connecting these projection points, is obtained. The exposure point data path for each of the micromirrors 38 is a path formed by projecting a passage path of the exposure point of each of the micromirrors which pass over the substrate 12 onto the coordinate system of the exposure image data.

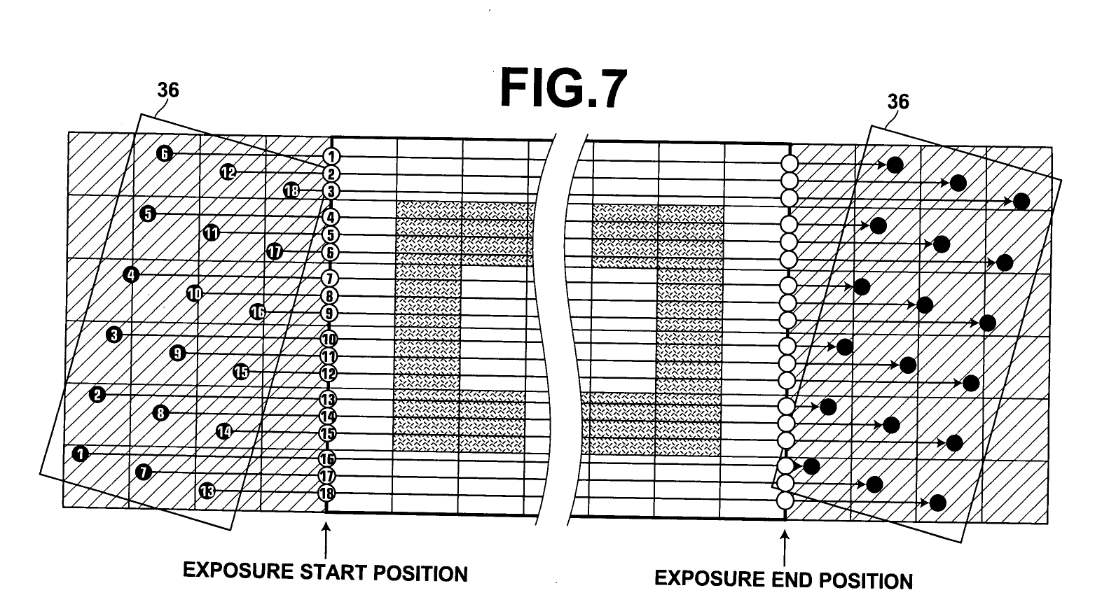

Then, the exposure point data path for each of the micromirrors 38 is output to the ideal exposure point data path obtainment means 42. The exposure point data path for each of the micromirrors 38 and the coordinate system of the exposure image data are associated with each other, as illustrated in FIG. 7. In FIG. 7, black circles represent projection points of the beam start position information and the beam end position information, projected onto the substrate 12 by each of the micromirrors 38. In FIG. 7, arrows represent exposure point data paths, and numbers in the black circles are mirror numbers. Shaded portions on both sides of the exposure image data are margin data portions, which are required when exposure is performed to form an exposure image represented by the exposure image data using the DMD 36, in which the micromirrors 38 are two-dimensionally arranged. For the purpose of explanation, the margin data portions are illustrated in FIG. 7. However, it is assumed that the margin data on the margin data portion is not stored in a memory.

Then, the ideal exposure point data path obtainment means 42 obtains an address of exposure image data in the memory corresponding to an exposure start position and an address of exposure image data in the memory corresponding to an exposure end position. The exposure start position is a position at which exposure for forming the exposure image is started by each of the micromirrors 38, and the exposure end position is a position at which exposure for forming the exposure image ends. These addresses are obtained based on the coordinate system of the exposure image data and the exposure point data path. In FIG. 7, white circles on the left side represent exposure start positions, and white circles on the right side represent exposure end positions.

Then, an ideal exposure point data path connecting two white circles is obtained for each of the micromirrors 38. The ideal exposure point data path is output to the ideal mirror data obtainment means 43. In actual processing, a readout start address and a readout end address of each of the micromirrors 38 are output as the ideal exposure point data path. The positions of the white circles correspond to readout start positions in the claims of the present application.

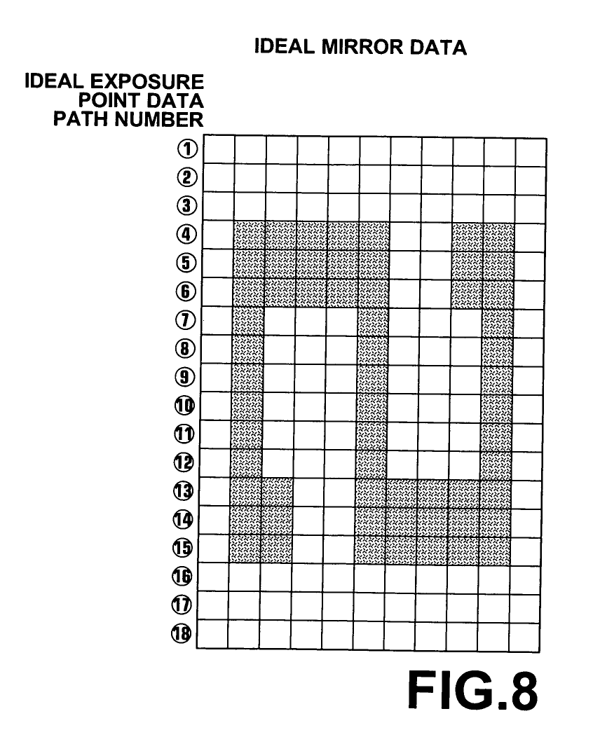

Then, the ideal mirror data obtainment means 43 reads out, based on the ideal exposure point data path for each of the micromirrors 38, exposure point data for each of the micromirrors 38 from the memory at predetermined sampling intervals, thereby ideal mirror data for each of the micromirrors 38 being obtained. At this time, the ideal mirror data is obtained in order of the numbers of the ideal exposure point data paths illustrated in FIG. 7, and finally, ideal mirror data illustrated in FIG. 8 is obtained. Data in each horizontal line to which a number is assigned is a set of ideal mirror data.

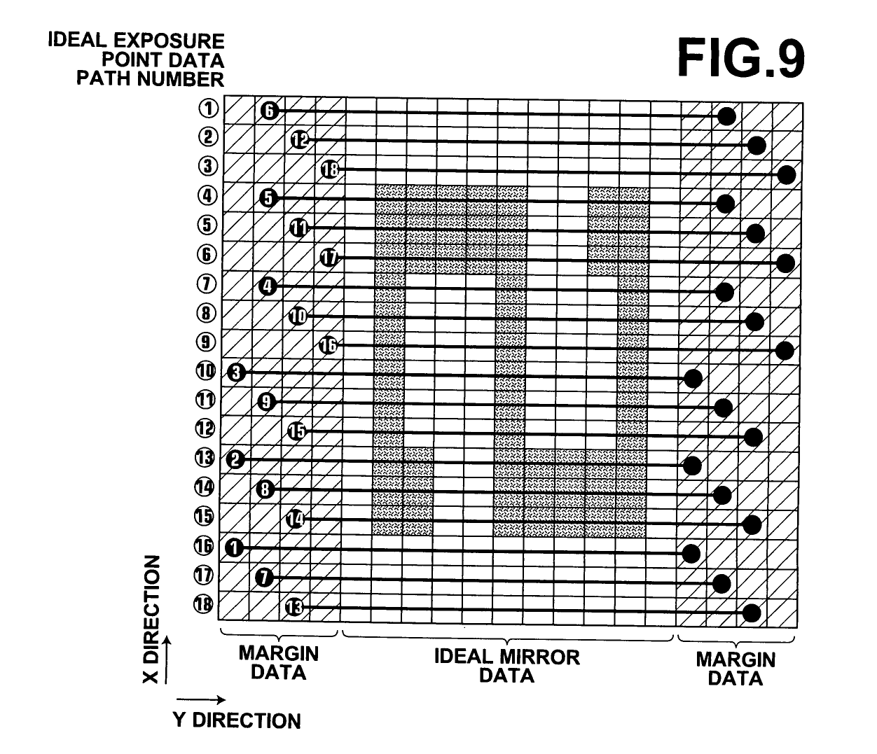

Then, the ideal mirror data, obtained as described above, is output to the margin data appending means 44. In the margin data appending means 44, margin data is appended to the ideal mirror data, as illustrated in FIG. 9. The margin data is data corresponding to the margin data portion illustrated in FIG. 7. The same number of sets of margin data is appended to each ideal mirror data. Further, the margin data in the present embodiment is data including only zero (0).

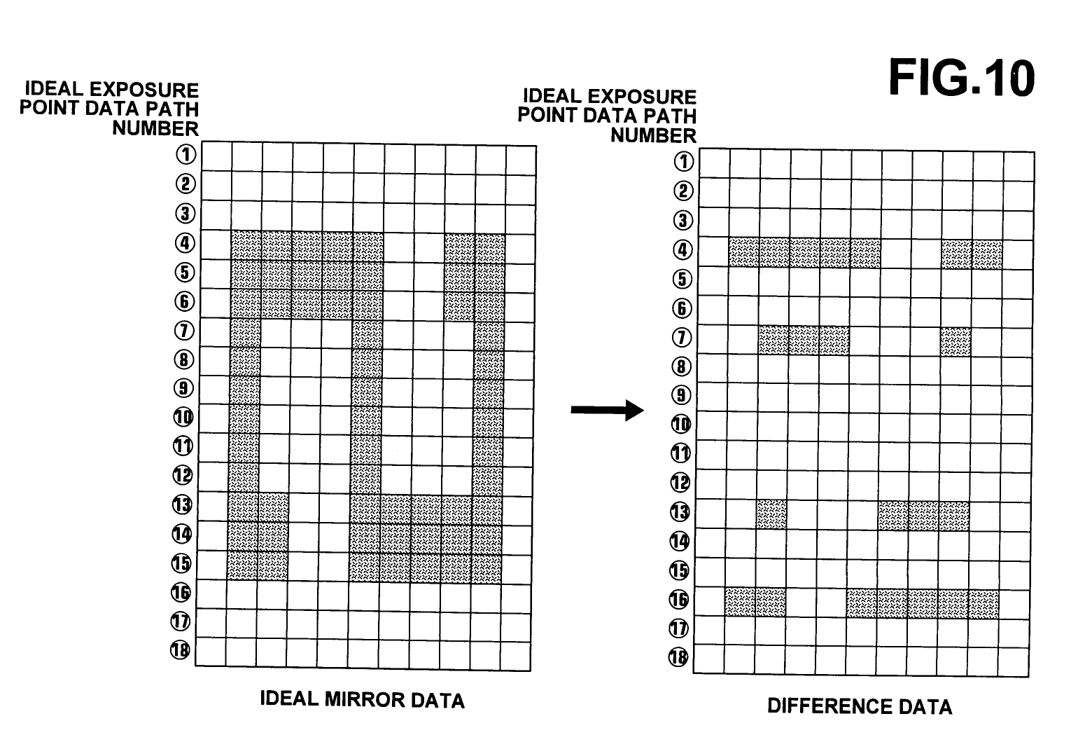

The ideal mirror data with margin is output to the compression processing means 45. Then, the compression processing means 45 performs run-length compression processing in Y direction illustrated in FIG. 9 to generate run-length data. In this case, a compression rate may be increased to compress more by sequentially obtaining a difference from data in the immediately upper row for each data in the second or lower row of the ideal mirror data (or ideal mirror data with margin), as illustrated in FIG. 10, and by performing run-length compression processing on the obtained difference data in the Y direction.

Then, the run-length data generated by the compression processing means 45 is output to the hardware processing unit 50 and input to the decompression processing means 51 of the hardware processing unit 50. Then, the run-length data is decompressed by the decompression processing means 51, and ideal mirror data with margin is generated again. The ideal mirror data with margin is output to the mirror data obtainment means 52.

The mirror data obtainment means 52 receives the ideal mirror data with margin, as described above. The mirror data obtainment means 52 also receives beam start position information and beam end position information for each of the micromirrors 38, which have been obtained by the exposure point data path obtainment means 41. Then, as illustrated in FIG. 9, the ideal mirror data with margin is associated with the beam start position information and the beam end position information for each of the micromirrors 38. Further, mirror data corresponding to an exposure point data path connecting the beam start position information and the beam end position information is extracted for each of themicromirrors 38. Accordingly, mirror data for each of the micromirrors 38 is obtained.

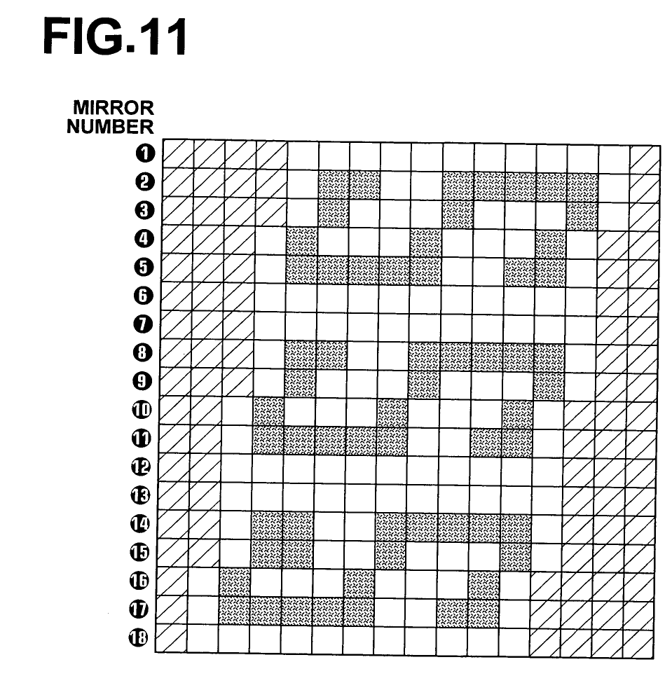

At this time, the mirror data is obtained in order of the numbers of the micromirrors 38, and each mirror data is arranged, as illustrated in FIG. 11.

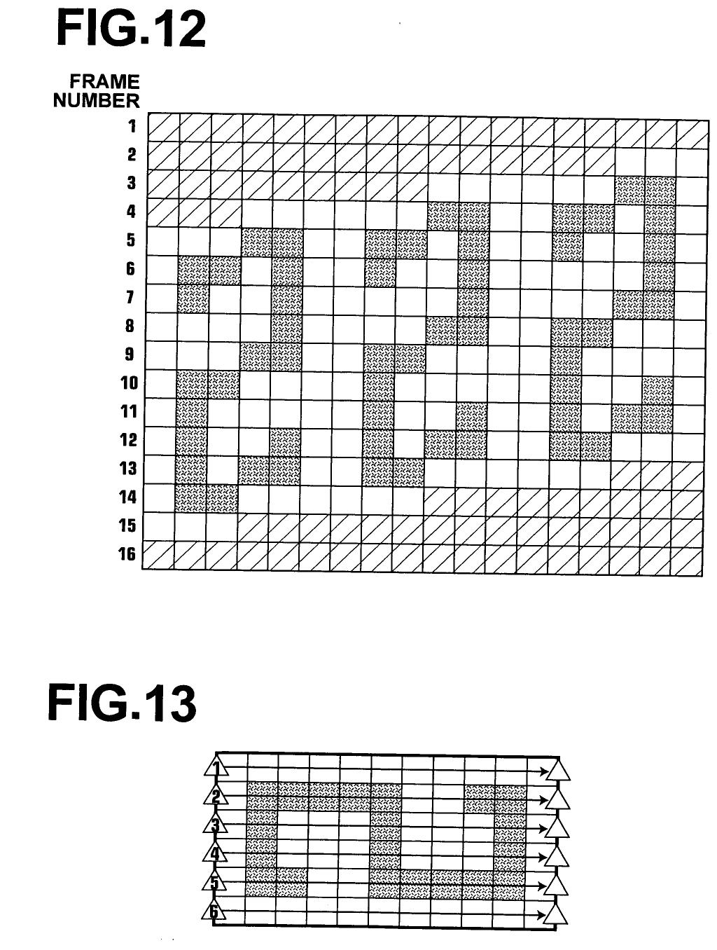

Then, the mirror data for each of the micromirrors 38 obtained by the mirror data obtainment means 52, as described above, is output to the frame data obtainment means 53. The frame data obtainment means 53 performs 90 degrees rotation processing or transposition processing using a matrix on the mirror data to obtain frame data, as illustrated in FIG. 12. In FIG. 12, the numbers are frame numbers, and data in each (horizontal) row to which each number is assigned is a set of frame data.

The frame data obtained by the frame data obtainment means 53, as described above, is sequentially output to the exposure head control unit 60 in order of the frame numbers.

The frame data is output to the exposure head control unit 60, as described above, and the movement stage 14 is moved toward an upstream side at a desired speed. The upstream side is the right side in FIG. 1. Specifically, the upstream side is a side on which the scanner 24 is set with respect to the gate 22. The downstream side is the left side in FIG. 1. Specifically, the downstream side is a side on which the cameras 26 are set with respect to the gate 22.

When the leading edge of the substrate 12 is detected by the camera or cameras 26, exposure processing starts. Specifically, the exposure head control unit 60 outputs a control signal based on the frame data to the DMD 36 of each of the exposure heads 30 as the movement stage 14 moves. Then, each of the exposure heads 30 exposes the substrate 12 to light by setting each of the micromirrors of the DMD 36 to on or off based on the input control signal.

Then, as the movement stage 14 moves, control signals are sequentially output to each of the exposure heads 30 and exposure is performed. When the rear edge of the substrate 12 is detected by the camera or cameras 26, exposure processing ends.

When the control signals are output from the exposure head control unit 60 to each of the exposure heads 30, a control signal corresponding to each position of each of the exposure heads 30 relative to the substrate 12 is sequentially output from the exposure head control unit 60 to each of the exposure heads 30 as the movement stage 14 moves. At this time, the control signals may be sequentially output from the exposure head control unit 60 to each of the exposure heads based on frame data as in the present embodiment. Although the frame data is generated in the present embodiment, it is not necessary that the frame data is generated. For example, a set of exposure point data corresponding to each position of each of the exposure heads 30 may be sequentially read out from each mirror data obtained for each of the micromirrors 38, and the exposure point data, which has been read out, may be output to each of the exposure heads 30.

In the exposure apparatus according to the present embodiment, an address in the memory at which exposure image data that represents an exposure image corresponding to an exposure start position of the exposure image of each of the micromirrors 38 is obtained as a readout start address of each of the micromirrors 38. Further, exposure image data is sequentially read out from each of the readout start addresses along the exposure point data path for each of the micromirrors 38 in the exposure image data corresponding to the exposure path of each of the micromirrors 38 on the substrate 12 to obtain ideal mirror data for each of the micromirrors 38. Therefore, it is possible to obtain the ideal mirror data that has the feature of images. Further, for example, when run-length compression processing is performed, it is possible to improve the compression rate. Hence, it is possible to further reduce the data volume.

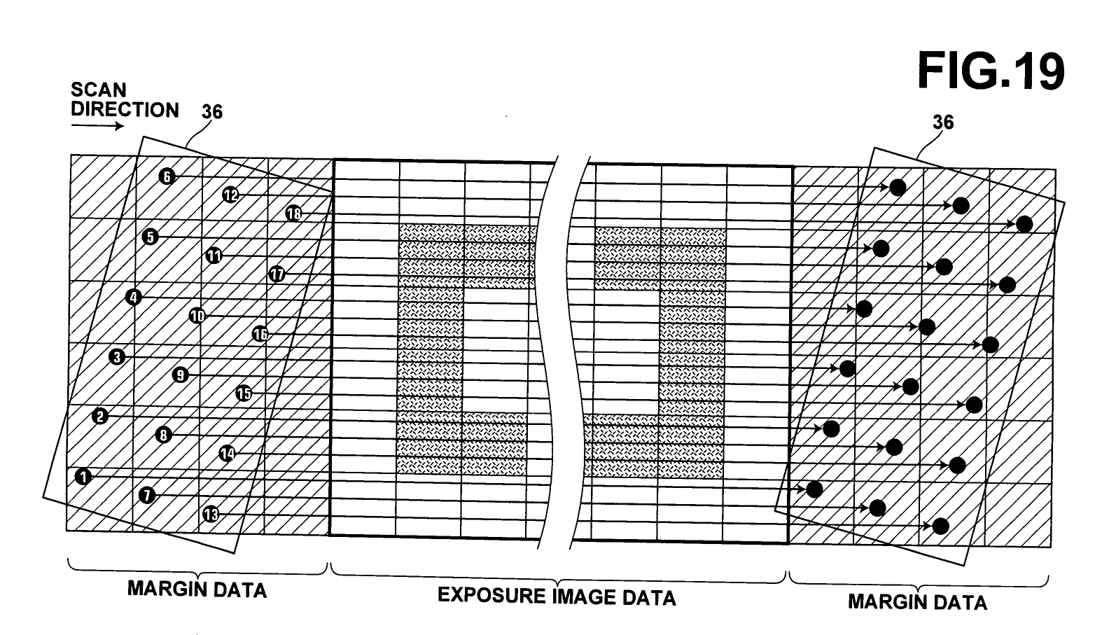

Further, when the same number of sets of margin data is appended to the ideal mirror data after obtainment of the ideal mirror data as in the above embodiment, it is possible to generate ideal mirror data with margin, as illustrated in FIG. 9. Therefore, it is possible to improve the compression efficiency in the run-length compression. In the above embodiment, the same number of sets of margin data is appended to the ideal mirror data after obtainment of the ideal mirror data. However, for example, when exposure point data from the beam start position information to the beam end position information in the exposure point data path is obtained for each of the exposure point data paths after the margin data is appended to the exposure image data, as illustrated in FIG. 19, the mirror data for each of the micromirrors 38 is data, as illustrated in FIG. 11. Specifically, since mirror data for each of the micromirrors 38 is shifted from each other in Y direction, it is impossible to maintain the feature of the exposure image. Further, the compression rate of the margin data becomes lower than that of the margin data in the present embodiment.

Further, in the above embodiment, the ideal exposure point data path obtainment means 42 obtains the ideal exposure point data path for each of the micromirrors 38. However, for example, when exposure point data paths for a plurality of micromirrors 38 are located in the same pixel data, it is not always necessary that the ideal exposure point data path is obtained for each of the micromirrors 38. For example, a single ideal representative exposure point data path may be obtained for the plurality of exposure point data paths located in the same pixel data. Then, mirror data for each of the micromirrors 38 may be obtained using the single ideal representative exposure point data path.

Specifically, for example, if the positional relationship between exposure image data and the exposure point data path for each of the micromirrors 38 is as illustrated in FIG. 7, three exposure point data paths are located in the same pixel data. Therefore, a single ideal representative exposure point data path, as illustrated in FIG. 13, is obtained for the three exposure point data paths, for example. The ideal representative exposure point data path is obtained by obtaining a representative exposure point data path and a representative readout start address of the representative exposure point data path. The representative exposure point data path is an exposure point data path representing the exposure point data paths. The representative exposure point data path may be obtained by selecting one of the three exposure point data paths. Alternatively, the representative exposure point data path may be imaginarily obtained by performing an additional operation based on the three exposure point data paths. Further, the representative readout start address may be obtained by selecting one of readout start addresses corresponding to the three exposure point data paths.

Then, the ideal representative exposure point data path, obtained as described above, is output to the ideal mirror data obtainment means 43. The ideal representative exposure point data path is associated with exposure image data by the ideal mirror data obtainment means 43. Then, exposure image data corresponding to each of the ideal representative exposure point data paths is read out at predetermined sampling intervals to obtain ideal representative mirror data in each of the ideal representative exposure point data paths. At this time, the ideal representative mirror data is obtained in order of numbers illustrated in FIG. 13.

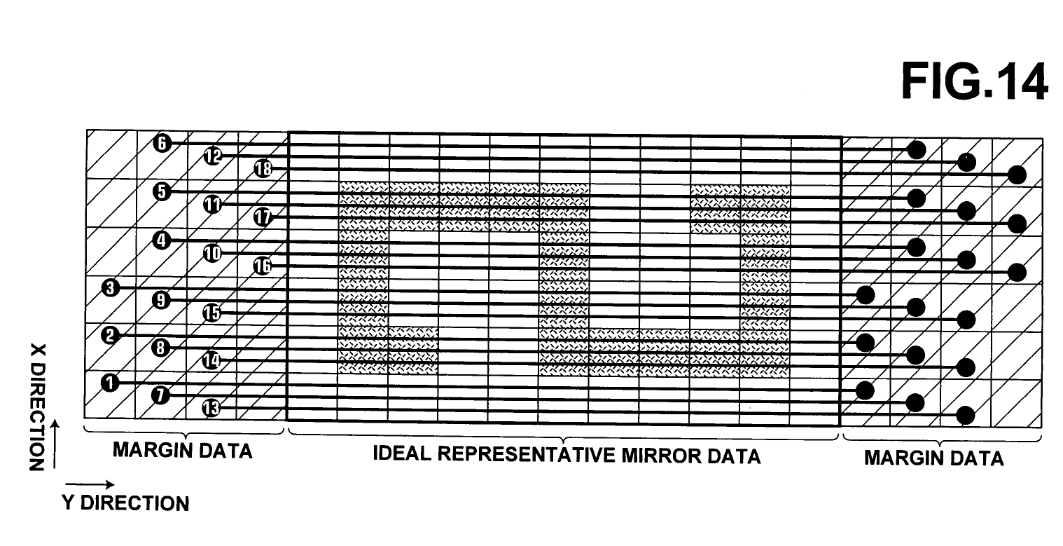

Then, the ideal representative mirror data, obtained as described above, is output to the margin data appending means 44. The margin data appending means 44 appends margin data to the ideal representative mirror data, as illustrated in FIG. 14.

Then, the ideal representative mirror data to which margin data has been appended (hereinafter, referred to as “ideal representative mirror data with margin”) is output to the compression processing means 45. The compression processing means 45 performs run-length compression processing in Y direction illustrated in FIG. 14 to generate run-length data.

Then, the run-length data, generated by the compression processing means 45, is output to the hardware processing unit 50 and input to the decompression processing means 51 of the hardware processing unit 50. Then, the run-length data is decompressed by the decompression processing means 51, and ideal representative mirror data with margin is generated again. The ideal representative mirror data with margin is output to the mirror data obtainment means 52.

The ideal representative mirror data with margin is input to the mirror data obtainment means 52, as described above. Further, beam start position information and beam end position information for each of the micromirrors 38 obtained by the exposure point data path obtainment means 41 is input to the mirror data obtainment means 52. Then, the ideal representative mirror data with margin is associated with beam start position information and beam end position information for each of the micromirrors 38, as illustrated in FIG. 14. At this time, in the above embodiment, a single exposure point data path was associated with ideal mirror data with margin in a single row. However, in the present embodiment, three exposure point data paths are associated with ideal representative mirror data with margin in a single row.

Then, a portion of the ideal representative mirror data with margin corresponding to each of the exposure point data paths is extracted and read out a plurality of times. Accordingly, mirror data for each of the micromirrors 38 is obtained. At this time, the mirror data is obtained in order of the mirror numbers illustrated in FIG. 14. Finally, mirror data illustrated in FIG. 11 is obtained in a manner similar to the above embodiment.

It is not necessary that the number of ideal representative exposure point data paths is one. The number of the ideal representative exposure point data paths may be any number as long as the number is less than the number of the plurality of exposure point data paths located in the same pixel data. The number of the ideal representative exposure point data paths should be determined based on desired image quality.

Further, when two or more ideal representative exposure point data paths are set for a single pixel data string, mirror data corresponding to each of the exposure point data paths should be obtained, for example, using ideal representative mirror data corresponding to an ideal representative exposure point data path that is the closest to each of the exposure point data paths.

When the ideal representative exposure point data path is obtained as in the above embodiment, and ideal representative mirror data in each of the ideal representative exposure point data paths is obtained, based on the ideal representative exposure point data path, it is possible to further reduce the data volume. Hence, it is possible to reduce the capacity of the memory and to increase the data transfer speed.

Further, in the above embodiment, the margin data is appended by the margin data appending means 44 of the software processing unit 40. However, it is not necessary that the margin data is appended by the margin data appending means 44. Alternatively, the margin data may be appended by the hardware processing unit 50, for example. Specifically, ideal mirror data or ideal representative mirror data is stored in a memory of the hardware processing unit 50 and an address at the beginning of each storage area in which ideal mirror data corresponding to each of the ideal exposure point data paths is stored is obtained as pointer information, for example. Alternatively, an address at the beginning of each storage area in which ideal representative mirror data corresponding to each of the ideal representative exposure point data paths is stored is obtained as pointer information, for example.

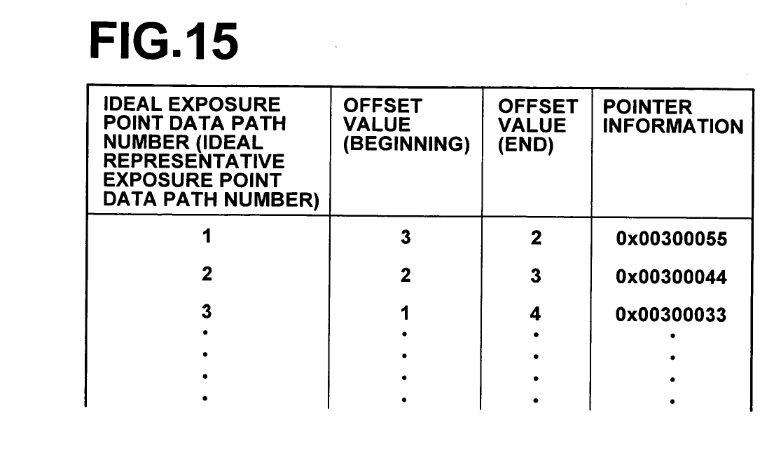

Then, as illustrated in FIG. 15, a table in which one of an ideal exposure point data path number and an ideal representative exposure point data path number, the number (offset value) of zeros in margin data appended to the beginning and the end of each ideal mirror data or ideal representative mirror data and the pointer information are associated with each other is created. The table is output to the hardware processing unit 50.

Then, the hardware processing unit 50 should read out, based the pointer information in the table, ideal mirror data or ideal representative mirror data corresponding to each of the ideal exposure point data paths or each of the ideal representative exposure point data paths. Further, the hardware processing unit 50 should append, based on an offset value in the table, a number of zeros represented by the offset value to the beginning and the end of the ideal mirror data or the ideal representative mirror data.

In the above embodiment, the exposure point data path for each of the micromirrors 38 is obtained without considering the distortion of the substrate 12 or the like, and mirror data corresponding to the exposure point data path is obtained. However, the exposure point data path for each of the micromirrors 38 may be obtained by considering the distortion of the substrate 12 and an ideal exposure point data path or an ideal representative exposure point data path may be obtained based on the exposure point data path.

A method for obtaining an exposure point data path by considering the distortion of the substrate 12 will be described.

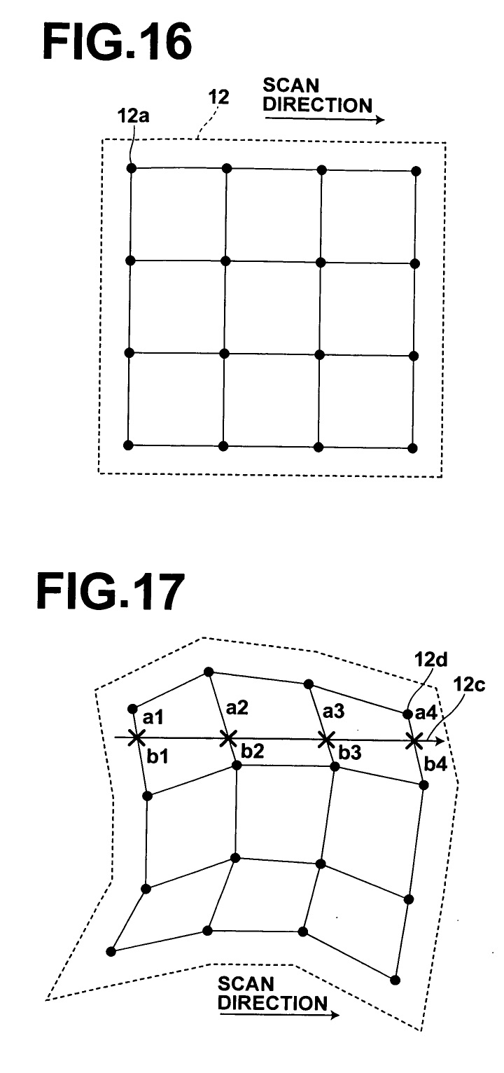

First, as illustrated in FIG. 16, a plurality of base marks 12a is provided on the substrate 12 based on predetermined base mark position information. The base marks 12a are holes formed on the substrate 12, for example. Alternatively, the base marks 12a may be lands, vias (via holes) or etching marks. Further, a predetermined pattern formed on the substrate 12, such as a pattern formed on a layer under a layer on which exposure processing will be performed, may be used as the base mark 12a, for example.

Then, the substrate 12 on which the base marks 12 have been provided, as described above, is placed at a predetermined position of the movement stage 14. Then, after the movement stage 14 is once moved along the guides 20 from the position illustrated in FIG. 1 to a predetermined initialization position on the upstream side, the movement stage 14 is moved toward the downstream side at a desired speed.

Then, when the substrate 12 on the movement stage 14, which is moved as described above, passes under the plurality of cameras 26, the cameras 26 photograph the substrate 12 to obtain photographed image data representing photographed images. Then, detection position information representing the positions of the base marks 12a on the substrate 12 is obtained based on the obtained photographed image data. The detection position information can be obtained based the positions of base mark images in the photographed images obtained by the cameras 26 and a movement distance of the movement stage 14 when the base marks 12a are photographed by the cameras 26. The movement distance of the movement stage 14 may be measured by a linear encoder, for example. Further, the base mark images of the base marks 12a may be obtained, for example, by extracting circular images. However, the base mark images may be obtained by using any known obtainment methods. Further, the detection position information of the base mark 12a is actually obtained as a coordinate value, and the coordinate system is the same as the coordinate system of the exposure image data. Further, the coordinate system of the base mark position information, as described above, is also the same coordinate system.

Then, the exposure path of each of the micromirrors 38 on the substrate 12 in actual exposure is obtained based on information about detection positions of the base marks 12a, which have been obtained as described above.

Specifically, detection position information 12d, which has been obtained as described above, and passing position information 12c about each of the micromirrors 38, which has been set in advance based on the positional relationship between the movement stage 14 and the exposure head 30, are associated with each other, as illustrated in FIG. 17. Then, the coordinate value of an intersection of a straight line connecting detection position information 12d and detection position information 12d that are adjacent to each other in a direction perpendicular to the scan direction and a straight line representing the exposure path 12c of each of the micromirrors 38 is obtained. Specifically, the coordinate value of a point indicated with x in FIG. 17 is obtained. Further, a distance from the mark x to each detection position information 12d that is adjacent to the mark x in the direction perpendicular to the scan direction is obtained. Then, a ratio between a distance from the mark x to detection position information 12d on one side and a distance from the mark x to detection position information 12d on the other side is obtained. Specifically, ratios a1:b1, a2:b2, a3:b3 and a4:b4 in FIG. 17 are obtained. These ratios represent an exposure path.

Then, an exposure point data path for each of the micromirrors 38 is obtained based on the ratios, obtained as described above, and exposure image data base position information 12e corresponding to the base mark position information plotted in the coordinate system of the exposure image data.

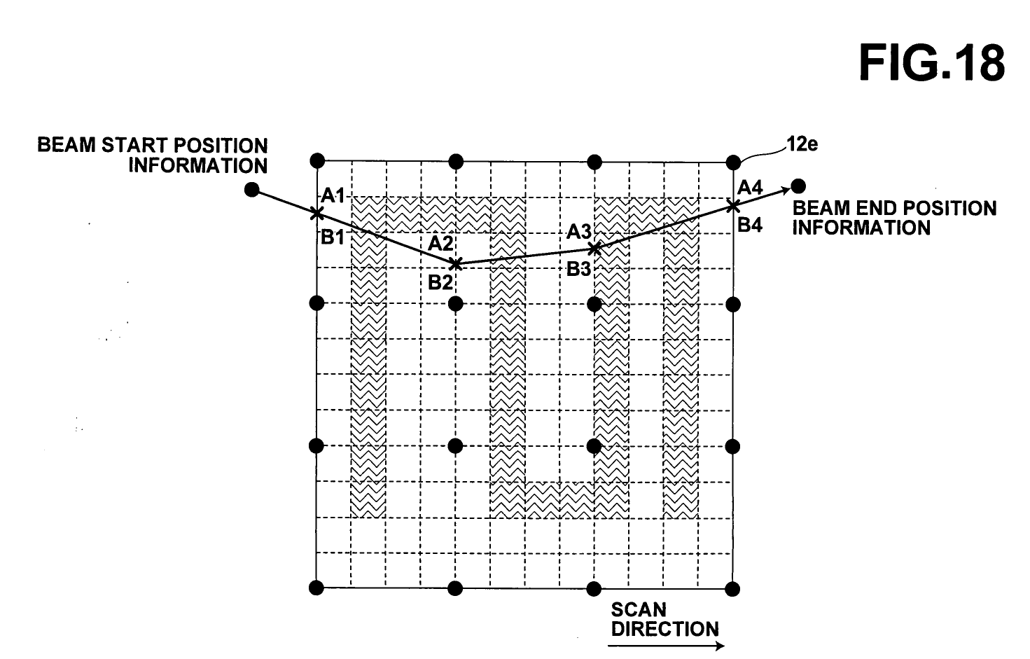

Specifically, as illustrated in FIG. 18, the coordinate values of points at which a straight line connecting exposure image data base position information 12e and exposure image data base position information 12e adjacent to each other in a direction perpendicular to the scan direction is divided based on the ratios, which have been obtained as described above, are obtained. In other words, the coordinate values of points that satisfy the following equations are obtained:

a1:b1=A1:B1

a2:b2=A2:B2

a3:b3=A3:B3

a4:b4=A4:B4.

A straight line connecting the points obtained as described above and projection points at which beam start position information and beam end position information for each of the micromirrors 38 have been projected onto the exposure image data is an exposure point data path for each of the micromirrors 38 when the distortion of the substrate 12 is taken into consideration.

The action in which an ideal exposure point data path or an ideal representative exposure point data path is obtained based on the exposure point data path for each of the micromirrors 38, which has been obtained as described above, and in which mirror data for each of the micromirrors 38 is obtained, is achieved in a manner similar to the action described above.

Further, the positional fluctuation of the movement stage 14 in a direction perpendicular to the direction of the movement of the movement stage 14, yawing of the movement stage 14 or the like may be taken into consideration in addition to the distortion of the substrate 12 and an exposure point data path in the coordinate system of the exposure image data may be obtained for each of the micromirrors 38. Further, an ideal exposure point data path or an ideal representative exposure point data path may be obtained based on the exposure point data path. Then, mirror data for each of the micromirrors 38 may be obtained based on the ideal exposure point data path or the ideal representative exposure point data path. Here, the positional fluctuation and the yawing of the movement stage 14 should be measured using a laser length meter or the like, for example.

Further, in the above embodiment, the exposure apparatus including the DMD as a spatial light modulation device was described. However, a transmissive spatial light modulation device may be used instead of the reflective spatial light modulation device, which was described above.

Further, in the above embodiment, a so-called flat-bed type exposure apparatus was used as an example. However, a so-called outer-drum type exposure apparatus may be used. The so-called outer-drum type exposure apparatus is an exposure apparatus having a drum about which a photosensitive material is wound.

Further, it is not necessary that the substrate 12, which is an object to be exposed in the above embodiment, is a printed circuit board. The substrate 12 may be a substrate of a flat panel display. Further, the shape of the substrate 12 may be a sheet form or an elongated form (flexible substrate or the like).

Further, the drawing method and the drawing apparatus of the present invention may be also applied to image drawing in a printer of an ink-jet type or the like. For example, a drawing point formed by ejecting ink may be formed in a manner similar to the present invention. Specifically, the drawing point formation unit of the present invention may be considered as each nozzle of a printer of an ink-jet type.

1. A method for obtaining drawing point data that is used when an image is drawn on a substrate by moving a plurality of drawing point formation units for forming drawing points based on drawing point data relative to the substrate and by sequentially forming the drawing points on the substrate according to the movement, the method comprising the steps of:
obtaining a drawing point data path corresponding to the drawing path of each of the drawing point formation units by associating the drawing path of each of the drawing point formation units on the substrate and image data representing the image with each other;
selecting the same position in each of the drawing point data paths with respect to the extending direction of the drawing point data paths as a readout start position in each of the drawing point data paths; and
obtaining drawing point data for each of the drawing point formation units by sequentially reading out the image data from the readout start position in each of the drawing point data paths along each of the drawing point data paths.

2. A method for obtaining drawing point data, as defined in claim 1, wherein the drawing point data in each of the drawing point data paths is sequentially obtained along the arrangement direction of the drawing point data paths.

3. A method for obtaining drawing point data, as defined in claim 1, wherein after the drawing point data for each of the drawing point formation units is obtained, a predetermined number of sets of margin data is appended to the beginning and the end of each of the drawing point data strings for each of the drawing point formation units, and wherein the drawing point data for each of the drawing point formation units is obtained by extracting and reading out the drawing point data corresponding to each of the drawing point data paths and a part of the margin data from each of the drawing point data strings to which the margin data has been appended.

4. A method for obtaining drawing point data, as defined in claim 1, wherein at least one representative drawing point data path, representing the plurality of drawing point data paths, is obtained, and wherein the number of the at least one representative drawing point data path is less than the number of the plurality of drawing point data paths, and wherein the drawing point data for each of the plurality of drawing point formation units corresponding to the plurality of drawing point data paths is obtained by reading out the image data a plurality of times from the readout start position along the obtained representative drawing point data path.

5. A method for obtaining drawing point data, as defined in claim 1, wherein the plurality of drawing point formation units is two-dimensionally arranged.

6. A method for obtaining drawing point data, as defined in claim 1, wherein a row of drawing point formation units, including a plurality of drawing point formation units, is inclined by a predetermined inclination angle with respect to the direction of the movement.

7. A drawing method, wherein drawing point data is obtained by using the method for obtaining drawing point data, as defined in claim 1, and wherein an image is drawn on the substrate based on the obtained drawing point data.

8. An apparatus for obtaining drawing point data that is used when an image is drawn on a substrate by moving a plurality of drawing point formation units for forming drawing points based on drawing point data relative to the substrate and by sequentially forming the drawing points on the substrate according to the movement, the apparatus comprising:
a drawing point data path obtainment means for obtaining a drawing point data path corresponding to the drawing path of each of the drawing point formation units by associating the drawing path of each of the drawing point formation units on the substrate and image data representing the image with each other; and
an ideal drawing point data obtainment means for obtaining drawing point data for each of the drawing point formation units by selecting the same position in each of the drawing point data paths with respect to the extending direction of the drawing point data paths as a readout start position in each of the drawing point data paths and by sequentially reading out the image data from the readout start position in each of the drawing point data paths along each of the drawing point data paths.

9. An apparatus for obtaining drawing point data, as defined in claim 8, wherein the ideal drawing point data obtainment means sequentially obtains the drawing point data in each of the drawing point data paths along the arrangement direction of the drawing point data paths.

10. An apparatus for obtaining drawing point data, as defined in claim 8, the apparatus further comprising:
a margin data appending means for appending a predetermined number of sets of margin data to the beginning and the end of each of the drawing point data strings for each of the drawing point formation units, each of the drawing point data strings being obtained by the ideal drawing point data obtainment means; and
a drawing point data obtainment means for obtaining the drawing point data for each of the drawing point formation units by extracting and reading out the drawing point data corresponding to each of the drawing point data paths and a part of the margin data from each of the drawing point data strings to which the margin data has been appended by the margin data appendix means.

11. An apparatus for obtaining drawing point data, as defined in claim 8, the apparatus further comprising:
an ideal representative drawing point data path obtainment means for obtaining at least one representative drawing point data path, representing the plurality of drawing point data paths, wherein the number of the at least one representative drawing point data path is less than the number of the plurality of drawing point data paths, and wherein the ideal drawing point data obtainment means obtains the drawing point data for each of the plurality of drawing point formation units corresponding to the plurality of drawing point data paths by reading out the image data a plurality of times from the readout start position along the representative drawing point data path obtained by the ideal representative drawing point data path obtainment means.

12. An apparatus for obtaining drawing point data, as defined in claim 8, wherein the plurality of drawing point formation units is two-dimensionally arranged.

13. An apparatus for obtaining drawing point data, as defined in claim 8, wherein a row of drawing point formation units, including a plurality of drawing point formation units, is inclined by a predetermined inclination angle with respect to the direction of the movement.

14. A drawing apparatus comprising:
an apparatus for obtaining drawing point data, as defined in claim 8; and
a drawing means for drawing an image on the substrate based on the drawing point data obtained by the apparatus for obtaining drawing point data.
